(19) United States
(12) Patent Application Publication
(10) Pub. No.: US 2013/0235166 A1
(43) Pub. Date: Sep. 12, 2013

(54) SYNCHRONISATION METHOD

(71) Applicants: Nick Jones, Cambridge (GB); Graham Drinkwater, Cambridge (GB)

(72) Inventors: Nick Jones, Cambridge (GB); Graham Drinkwater, Cambridge (GB)

(73) Assignee: CAMBRIDGE SILICON RADIO LIMITED, Cambridge (GB)

(21) Appl. No.: 13/414,113

(22) Filed: Mar. 7, 2012

(51) Int. Cl. H04N 13/04

(52) U.S. Cl. 348/51; 348/E13.075

(57) ABSTRACT

A method by which a transmitter and receiver synchronise. The transmitter and receiver are operable in accordance with a protocol which mandates that some transmissions are jittered. The method comprises the transmitter transmitting a pseudo-random seed to the receiver; determining a jitter value based on the pseudo-random seed; and transmitting a synchronisation packet to the receiver at a time determined by the jitter value. The receiver receives the pseudo-random seed from the transmitter; determines timing of a receive window for the synchronisation packet based on the pseudo-random seed; opens the receive window at the determined time; and receives the synchronisation packet within the receive window.

The present disclosure relates to synchronising a transmitter and receiver. Suitably, the present disclosure is implemented in a system comprising a 3D television and 3D glasses, to maintain synchronisation between each shutter of the glasses and the corresponding image transmitted by the television.

The revival of 3D entertainment has led to a surge of 3D televisions entering the domestic market. In conjunction with a pair of 3D glasses, the 3D televisions enable viewers to perceive a 3D image. Typically, 3D images are conveyed by a 3D television using stereoscopy and filtered for viewing by liquid crystal (LC) shutter glasses. Filming in 3D is carried out using two cameras separated by the average distance between a person's pupils. The 3D television displays alternate images from the two cameras, one image intended for the right eye and the other image intended for the left eye. The rate at which the images alternate between the right and left image is sufficiently high to give the impression to a viewer that a continuous 3D image is being displayed rather than alternate 2D images. The LC shutters “open” and “close” alternately, such that the right shutter is open when the image for the right eye is displayed by the 3D television and closed when the image for the left eye is displayed. Conversely, the left shutter is open when the image for the left eye is displayed by the 3D television and closed when the image for the right eye is displayed. The liquid crystal layer in the LC shutters changes state on application of a voltage across it. When no voltage is applied, the LC layer is visibly transparent, and when a voltage is applied across it the layer turns dark. Thus, the shutters are “opened” and “closed” by application and removal of a voltage across the LC layer of the shutters.

The application and deactivation of the voltage across the LC layer of the shutters may be controlled by a small device that can be incorporated into the 3D glasses, for example a Bluetooth device. In such an application, the controller device in the LC shutters operates in conjunction with a controller device in the 3D television to maintain synchronisation of the shutters with the images displayed by the television. Maintaining synchronisation is very important. If the shutters are not precisely synchronised with the images displayed by the television, then one of the shutters of the glasses may be open when the television switches between the image intended for one eye and the image intended for the other eye. This may result in the viewer experiencing flickering and/or a distorted picture (crosstalk).

It is advantageous for the power drawn by the controller device in the 3D glasses to be very low because the 3D glasses are typically battery operated.

Thus, there is a need for a low power controller device that is able to maintain precise synchronisation.

According to a first aspect of the disclosure there is provided a transmitter operable in accordance with a protocol which mandates that some transmissions are jittered, the transmitter configured to synchronise with a receiver by: transmitting a pseudo-random seed to the receiver; determining a jitter value based on the pseudo-random seed; and transmitting a synchronisation packet to the receiver at a time determined by the jitter value.

Suitably, the protocol is the Bluetooth Low Energy protocol.

Suitably, the synchronisation packet is a Bluetooth Low Energy advertising packet.

Suitably, the transmitter is incorporated into a 3D television.

Suitably, the synchronisation packet comprises timing information indicative of the times at which the television displays images for reception by left and right eyes.

According to a second aspect of the disclosure there is provided a method by which a transmitter synchronises with a receiver, the transmitter and receiver operable in accordance with a protocol which mandates that some transmissions are jittered, the method comprising: transmitting a pseudo-random seed to the receiver; determining a jitter value based on the pseudo-random seed; and transmitting a synchronisation packet to the receiver at a time determined by the jitter value.

According to a third aspect of the disclosure there is provided a receiver operable in accordance with a protocol which mandates that some transmissions are jittered, the receiver configured to synchronise with a transmitter by receiving a pseudo-random seed from the transmitter; determining timing of a receive window for a synchronisation packet based on the pseudo-random seed; opening the receive window at the determined time; receiving the synchronisation packet within the receive window; and closing the receive window following receipt of the synchronisation packet.

Suitably, determining timing of a receive window comprises: determining an expected time of arrival of a synchronisation packet based on the pseudo-random seed; and determining a time period of the receive window based on the expected time of arrival of the synchronisation packet.

Suitably, the protocol is the Bluetooth Low Energy protocol.

Suitably, the receiver is incorporated into a pair of 3D glasses.

Suitably, the receiver is further configured to control the timing of the shutters of the 3D glasses based on timing information in the synchronisation packet.

According to a fourth aspect of the disclosure there is provided a method by which a receiver synchronises with a transmitter, the transmitter and receiver operable in accordance with a protocol which mandates that some transmissions are jittered, the method comprising: receiving a pseudo-random seed from the transmitter; determining timing of a receive window for a synchronisation packet based on the pseudo-random seed; opening the receive window at the determined time; receiving the synchronisation packet within the receive window; and closing the receive window following receipt of the synchronisation packet.

Suitably, determining timing of a receive window comprises: determining an expected time of arrival of a synchronisation packet based on the pseudo-random seed; and determining a time period of the receive window based on the expected time of arrival of the synchronisation packet.

Suitably, the receiver is incorporated into a pair of 3D glasses, the method further comprising: controlling the timing of the shutters of the 3D glasses based on timing information in the synchronisation packet.

The present invention will now be described by way of example with reference to the accompanying drawings. In the drawings:

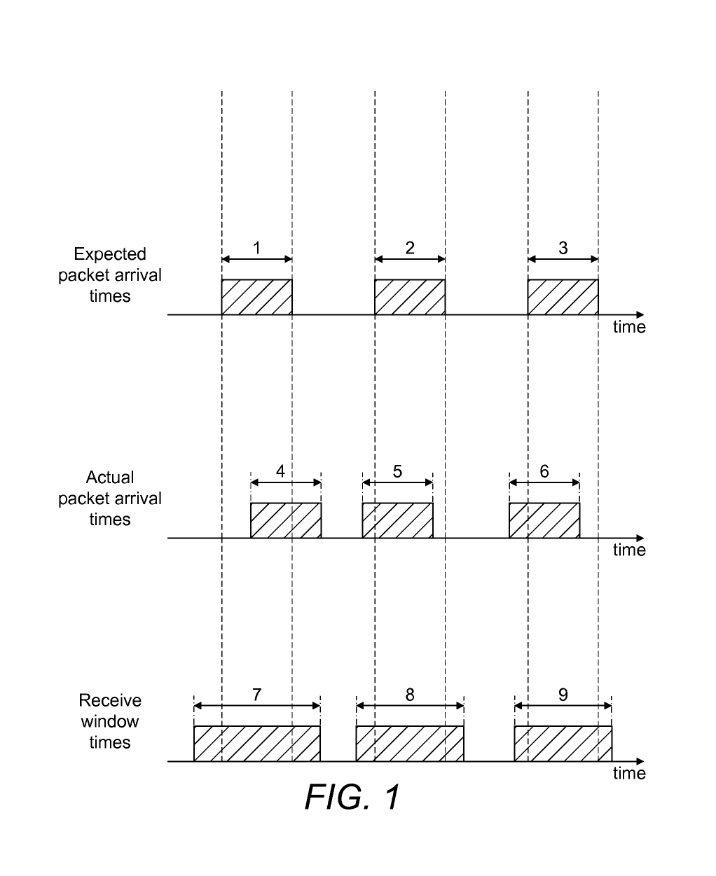

FIG. 1 illustrates the times at which a receiver expects packets to arrive, the time at which those packets actually arrive, and the times at which the receiver is operable to receive the packets;

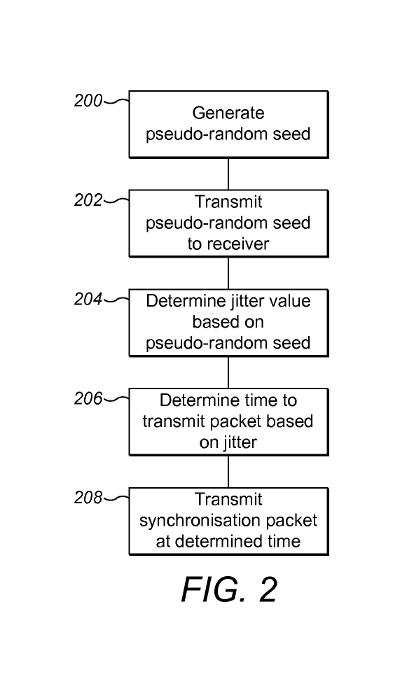

FIG. 2 illustrates a synchronisation method implemented at a transmitter;

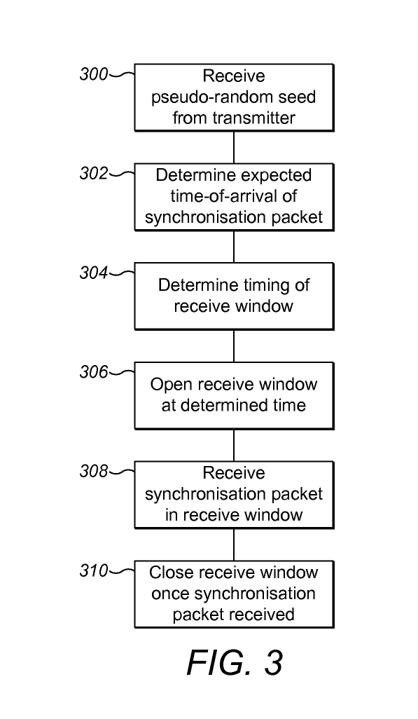

FIG. 3 illustrates a synchronisation method implemented at a receiver;

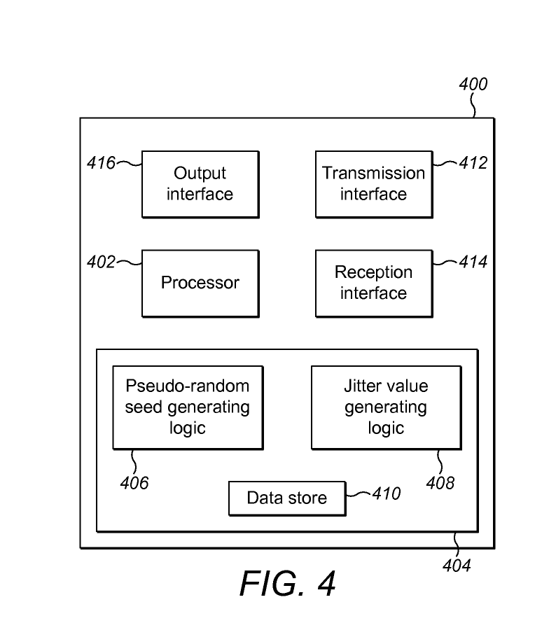

FIG. 4 illustrates an exemplary computing-based device in which the synchronisation method of FIG. 2 may be implemented;

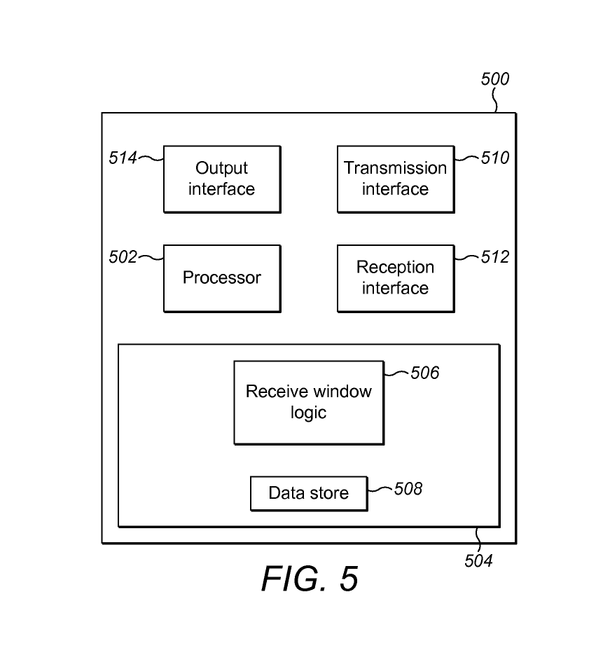

FIG. 5 illustrates an exemplary computing-based device in which the synchronisation method of FIG. 3 may be implemented;

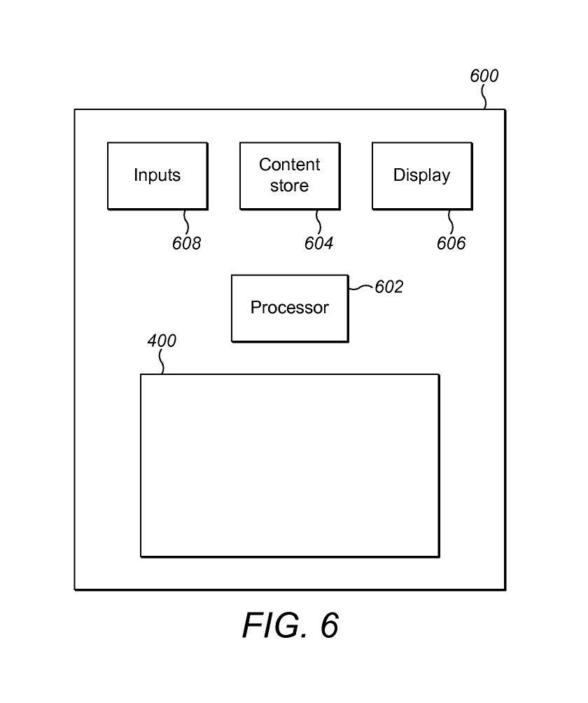

FIG. 6 illustrates an example 3D television

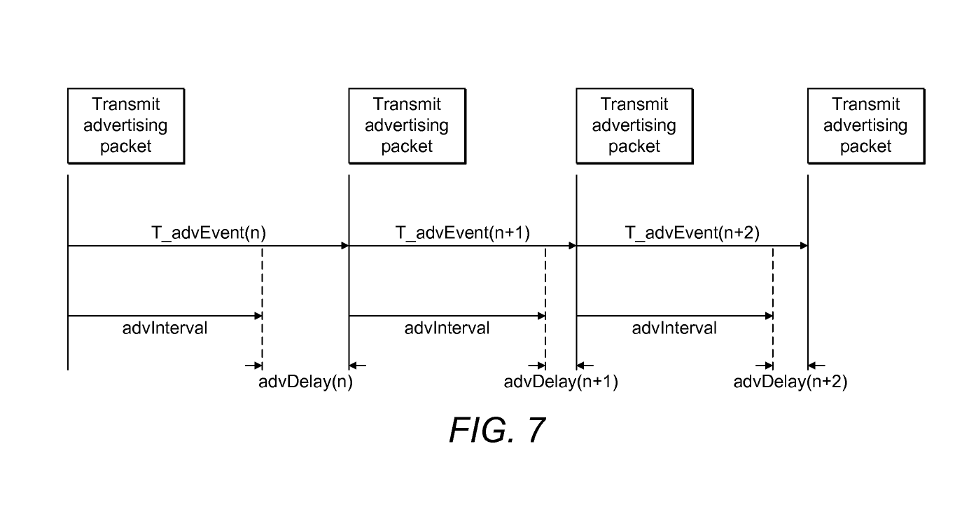

FIG. 7 illustrates the transmission times of packets from a transmitter;

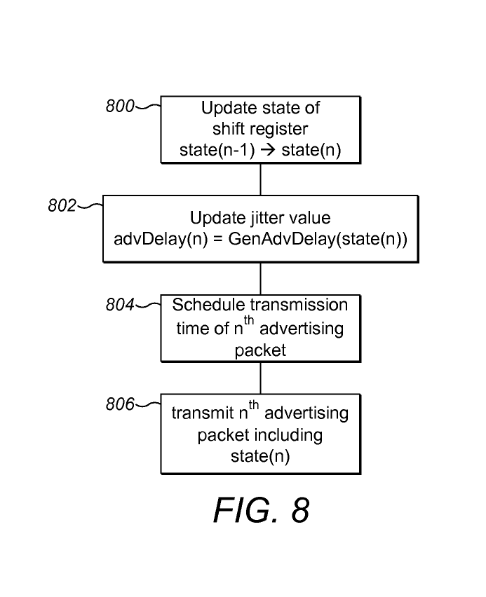

FIG. 8 illustrates a synchronisation method implemented at a transmitter;

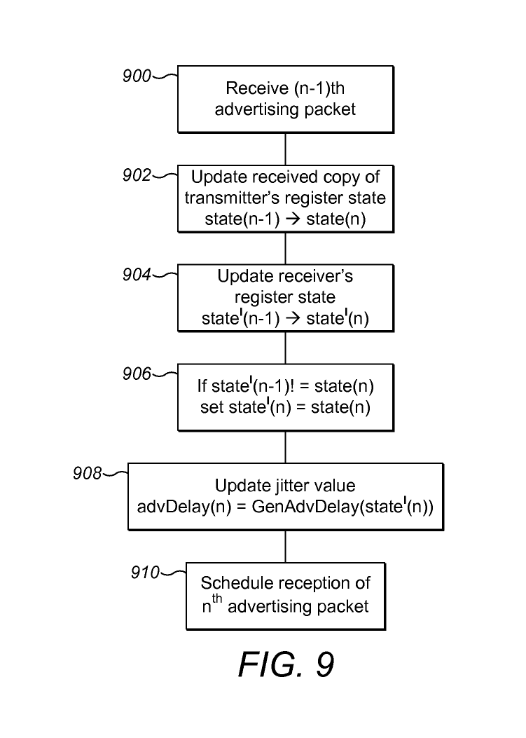

FIG. 9 illustrates a synchronisation method implemented at a receiver; and

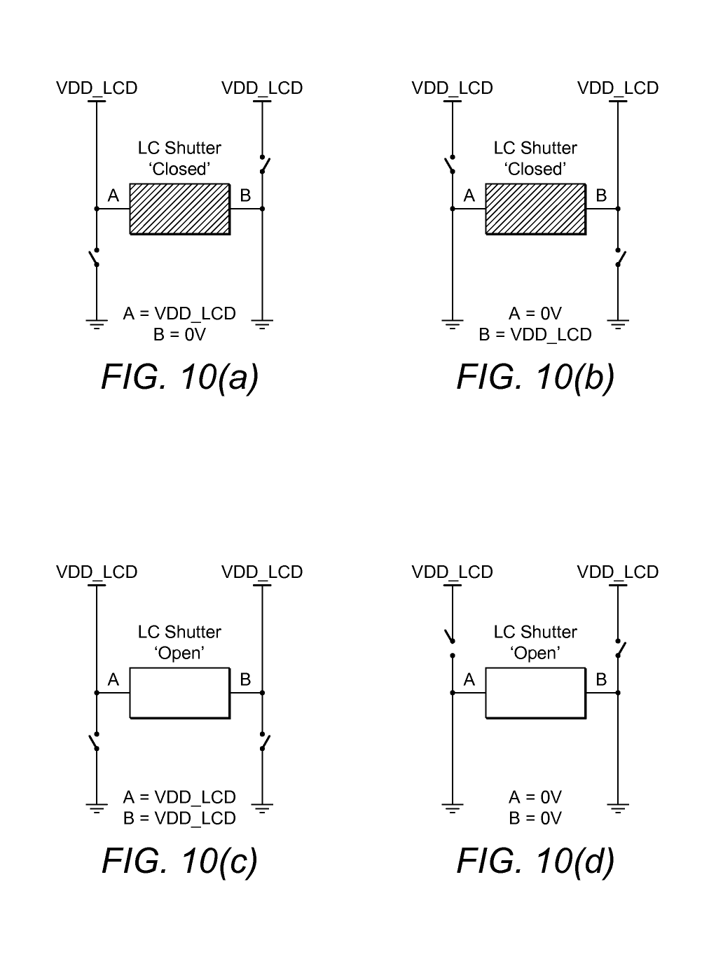

FIG. 10 illustrates open and closed states of liquid crystal shutters.

In the example of the 3D television and 3D glasses being controlled by respective Bluetooth devices, the Bluetooth device in the television and the Bluetooth device in the glasses may communicate in accordance with the Bluetooth Low Energy (BLE) protocol defined in the Bluetooth Specification version 4.0. This is preferred to those devices communicating in accordance with the Bluetooth Basic Rate/Enhanced Data Rate protocol because the 3D glasses are battery powered and may be required to operate for lengthy periods, thus minimising the power required for communication with the television is desirable.

In accordance with the BLE protocol, streams of advertising packets are transmitted from the television (acting as a BLE master device) to the glasses (acting as a BLE slave device) approximately every 500 ms. These advertising packets comprise timing information about the timing of the alternating images displayed by the television. The glasses use this timing information to correct the timing of the shutters, so as to synchronise the shutters with the alternating images.

The BLE protocol in the Bluetooth specification version 4.0 requires that the advertising packets be jittered. This means that each packet is transmitted at a small deviation in time from the nominal time at which the receiver expects the packet to be transmitted. Jittering is required in the BLE protocol to reduce the likelihood of a transmitted packet colliding with a packet transmitted from another source that happens to be synchronised to the nominal time and transmitting on the same frequency.

As a result of jittering, the Bluetooth receiver in the 3D glasses does not know exactly when it will receive an advertising packet from the Bluetooth transmitter in the 3D television. In the example illustrated in FIG. 1, the receiver expects advertising packets to be received during time periods 1, 2 and 3. However, as a result of these packets being jittered by the transmitter, the receiver actually receives the packets during time periods 4, 5 and 6. Typically, the receiver knows the maximum jitter that can be applied to the advertising packets. This may be mandated by the protocol. Alternatively, the transmitter may inform the receiver of the maximum jitter that it will apply to an advertising packet. Thus, in order to ensure that the receiver receives each advertising packet, the receiver is operable to receive a packet during a receive window which encompasses a time frame allowing for the maximum jitter preceding and after the expected arrival of the packet. In other words, the receive window starts at a time equal to the expected start of the packet minus the maximum jitter time, and the receive window ends at a time equal to the expected end of the packet plus the maximum jitter time. The receive window is thus open for time periods 7, 8 and 9 in FIG. 1.

The receive window during which the receiver is operable to receive a packet is significantly longer than the duration of the received packet. Long receive windows drain the power of a receiver. In low energy platforms, for example those running off coin cells (as is typical in the case of 3D glasses), this power drain is particularly problematic.

The following description relates to communications between devices which operate according to a protocol which mandates that some transmissions are jittered. In an exemplary case, this protocol is the Bluetooth Low Energy protocol. The example system described below operates in accordance with the Bluetooth Low Energy protocol. However, the methods described below apply equally to any protocol which requires that some transmissions are jittered.

In an exemplary Bluetooth Low Energy system, a first device communicates with a second device. The accuracy of an internal device clock is limited by the regularity of the frequency of the crystal oscillator which generates the clocking signal. Hence, clocks in different devices drift away from each other over time. This is a particular problem for low energy, low cost devices which generally operate using relatively inaccurate clocks. To maintain synchronisation between the devices, the first device transmits synchronisation packets to the second device. Suitably, these synchronisation packets contain timing information which the second device uses to adjust the clocking of its operations. For example, the timing information may be an indication of the timing of the clock of the first device. As a result of the clock drift problem, frequent synchronisation packets are exchanged to maintain synchronisation.

In the exemplary Bluetooth Low Energy system, synchronisation information may be transmitted in advertising packets. Advertising packets are defined in the Bluetooth specification version 4.0. The Bluetooth specification requires that advertising packets are transmitted with a random jitter, i.e. with a random time offset from the expected time of transmittal. The value of the jitter is determined by a pseudo-random seed which is generated by the transmitter. In known methods, the jitter applied by a transmitter to an advertising packet is not known by the receiver of the advertising packet. Thus, the receiver opens its receive window for a long time prior to and after the expected time of arrival of the advertising packet to ensure that the jittered advertising packet is received. When the receive window is open, the receiver processes every signal that it receives, i.e. amplifies, mixes, demodulates, filters and performs baseband processing of every signal. All of this processing is power intensive. When the receive window is closed, the receiver ignores all signals that it could otherwise receive. Thus, the receiver mode in which the receive window is open is a high power consumption mode relative to the receiver mode in which the receiver window is closed.

The methods described with respect to FIGS. 2 and 3 reduce the power consumption of a low energy receiver by reducing the time for which the receiver has its receive window open. The methods described with respect to FIGS. 2 and 3 are for illustrative purposes only. Not all the method steps are necessarily required, and the steps do not necessarily need to occur in the order illustrated. In the following description, the transmitter is incorporated into a device which transmits synchronisation packets to a receiver, such as the first device described above. Similarly, the receiver is incorporated into a device which receives synchronisation packets from a transmitter, such as the second device described above.

The operation of the transmitter will now be described with respect to FIG. 2. At step 200, the transmitter generates a pseudo-random seed. At step 202, the transmitter transmits the pseudo-random seed to the receiver. At step 204, the transmitter determines a jitter value based on the pseudo-random seed. At step 206, the transmitter determines a time to transmit a synchronisation packet based on the determined jitter value. Suitably, there is a nominal time of transmittal known to both the transmitter and the receiver, and the offset of the actual time of transmittal from that nominal time is given by the jitter value. For example, the nominal time of transmittal may be the beginning of a master time slot as defined by the Bluetooth specification version 4.0. At step 208, the transmitter transmits a synchronisation packet at the determined time of transmittal. Suitably, the pseudo-random seed is transmitted to the receiver in a previous synchronisation packet to the synchronisation packet whose time of transmittal is dependent on the pseudo-random seed. The receiver may leave its receive window open following receipt of the pseudo-random seed in order to capture a succeeding synchronisation packet that it determines it is about to receive. Suitably, this previous synchronisation packet is an advertising packet.

An exemplary implementation of the operation of the transmitter will now be described with reference to FIGS. 7 and 8. In this example, the pseudo-random seed is generated using a shift register, preferably a linear feedback shift register (LFSR). The pseudo-random seed is the state of the shift register. The shift register is initialised with an initial state. The shift register is clocked prior to the scheduling of an advertising packet transmission. Following this operation, the shift register outputs a state. This is illustrated on FIG. 8 as updating the state of the shift register at step 800. The transmitter determines the jitter value to be a function of the outputted state. In FIGS. 7 and 8, this jitter value is referred to as advDelay. For the ith advertising packet, the advDelay is calculated as:

advDelay(i)=GenAdvDelay(state(i)) (equation 1)

where advDelay(i) is the delay (jitter) applied to the ith advertising packet's transmission, state(i) is the ith state of the shift register, and GenAdvDelay is a function which maps the register state bits to a time delay (jitter). This is illustrated at step 802 on FIG. 8.

Suitably, the advDelay represents a value between 0 and 10 milliseconds.

At step 804 of FIG. 8, the transmitter determines the time at which to transmit the advertising packet based on the calculated jitter value. In this example, there is a predetermined minimum interval between advertising packet transmissions, illustrated as advInterval in FIG. 7. The time between packet transmissions is determined to be the addition of the advInterval and the advDelay:

T_advEvent(i)=advInterval+advDelay(i) (equation 2)

where T_advEvent(i) is the time in between the transmissions of the i−1th and ith advertising packets, advInterval is the predetermined minimal interval between advertising packet transmissions, and advDelay(i) is the delay (jitter) applied to the ith advertising packet transmission.

At step 806 on FIG. 8, the transmitter transmits the ith advertising packet at the determined time T_advEvent(i) relative to the transmitter's clock. Preferably, the transmitter transmits the ith register state to the receiver in the ith advertising packet. The receiver is thus able to calculate the expected time of arrival of the (i+1)th advertising packet using the ith register state as described below.

In the case that a LFSR is used to generate the pseudo-random seed, the LFSR is preferably implemented in hardware with associated hardware or software logic. Suitably, the LFSR produces a maximum-length sequence. It cycles through all possible states within the shift register excluding the state in which all the bits are zero. This maximises the randomness of the number sequence outputted from that LFSR.

The operation of the receiver will now be described with respect to FIG. 3. At step 300, the receiver receives a pseudo-random seed from the transmitter. At step 302, the receiver determines an expected time of arrival of a synchronisation packet based on the pseudo-random seed. For example, the receiver may derive the jitter value from the pseudo-random seed. If the offset of the actual time of the transmittal of the synchronisation packet from the nominal time of transmittal is given by the jitter value, then the receiver determines the expected time of arrival of the synchronisation packet using the jitter value. At step 304, the receiver determines the time period of a receive window based on the expected time of arrival of the synchronisation packet. The receive window is the time during which the receiver is operable to receive a signal. At step 306, the receiver opens its receive window at the determined time period. At step 308, the receiver receives the synchronisation packet transmitted by the transmitter within the receive window. At step 310, the receiver closes the receive window. The receiver closes the window once the synchronisation packet has been received. Preferably, the receiver closes the window immediately after receipt of the synchronisation packet.

Thus, the receive window is only open during the time period when the synchronisation packet is being received. This is in contrast to known methods in which the receive window is open for much longer to receive the synchronisation packet. Thus, the methods disclosed herein reduce power consumption at the receiver compared to known methods.

An exemplary implementation of the operation of the receiver will now be described with reference to FIG. 9. This exemplary implementation is compatible with the transmitter implementation of FIGS. 7 and 8. In this example, the pseudo-random seed is generated in the receiver using a shift register, preferably a linear feedback shift register (LFSR). The pseudo-random seed is the state of the shift register.

At step 900, the receiver 900 receives an advertising packet from the transmitter, referred to in FIG. 9 as the (n−1)th advertising packet. This advertising packet contains the nth state of the transmitter shift register. The receiver holds a copy of the current transmitter shift register state in a store. The receiver updates the stored transmitter shift register state with the received nth state at step 902.

As described above, the receiver also has a shift register. The receiver operates such that the state of the receiver shift register is maintained in synch with the state of the transmitter shift register. At step 904 the receiver clocks the receiver shift register. Following this operation, the receiver shift register outputs a state. This is illustrated on FIG. 9 as updating the state of the shift register at step 904.

At step 906, the receiver performs a check to see if the state of the receiver shift register matches the received state of the transmitter shift register. If it does not, then the receiver replaces the receiver shift register state with the received transmitter shift register state. This is calculated as:

If state′(n)!=state(n)

Set state′(n)=state(n) (equation 3)

where state′(n) is the nth state of the receiver shift register, and state(n) is the nth state of the transmitter shift register.

At step 908, the receiver determines the jitter value using the same method as described above for the transmitter with reference to FIGS. 7 and 8. The receiver determines the jitter value to be a function of the current receiver shift register state. In FIG. 9, this jitter value is referred to as advDelay.

advDelay(n)=GenAdvDelay(state′(n)) (equation 4)

where advDelay(n) is the delay (jitter) to be applied to the next advertising packet's transmission, state(n) is the nth state of the shift register, and GenAdvDelay is a function which maps the register state bits to a time delay (jitter).

Suitably, the advDelay represents a value between 0 and 10 milliseconds.

At step 910 of FIG. 9, the receiver determines the time at which it expects to receive the next advertising packet based on the calculated jitter value. In this example, there is a predetermined minimum interval between advertising packet transmissions, illustrated as advInterval in FIG. 7. The time between packet receipts is determined to be the addition of the advInterval and the advDelay:

T_advEvent(n)=advInterval+advDelay(n) (equation 5)

where T_advEvent(n) is the time in between the receipt of the n−1th and nth advertising packets, advInterval is the predetermined minimal interval between advertising packet transmissions, and advDelay(n) is the delay (jitter) applied to the nth advertising packet transmission.

At step 910 on FIG. 9, the receiver determines to receive the nth advertising packet at the determined time T_advEvent(i) relative to the receiver's clock.

In the case that a LFSR is used to generate the pseudo-random seed, the LFSR is preferably implemented in hardware with associated hardware or software logic. Suitably, the LFSR produces a maximum-length sequence. It cycles through all possible states within the shift register excluding the state in which all the bits are zero. This maximises the randomness of the number sequence outputted from that LFSR.

In order to save power, the receiver may not receive one or more advertising packets. In this case, the receiver still performs steps 904, 908 and 910 of FIG. 9. However, since it does not receive an advertising packet it does not update the received copy of the transmitter's register state, and it does not perform the check that the receiver and transmitter's respective register states are synchronised.

Reference is now made to FIG. 4. FIG. 4 illustrates a computing-based device 400 in which the described transmitter can be implemented. The computing-based device may be an electronic device. For example, the computing-based device may be a television. The computing-based device illustrates functionality used for generating a pseudo-random seed and a jitter value, and for transmitting data.

Computing-based device 400 comprises a processor 402 for processing computer executable instructions configured to control the operation of the device in order to perform the synchronisation method. The computer executable instructions can be provided using any computer-readable media such as memory 404. Further software that can be provided at the computer-based device 400 includes pseudo-random seed generating logic 406 which implements step 200 of FIG. 2 and jitter generating logic 408 which implements step 204 of FIG. 2. Alternatively, the pseudo-random seed generator and/or jitter value generator are implemented partially or wholly in hardware. Data store 410 stores data such as the generated pseudo-random seed and jitter value. Computing-based device 400 further comprises a transmission interface 412 which implements steps 202 and 208 of FIG. 2, and a reception interface 414 for receiving data. Computing-based device 400 also comprises an output interface 416. For example, the output interface 416 may output instructions to control an electronics device, for example a 3D television. Reference is now made to FIG. 5. FIG. 5 illustrates a computing-based device 500 in which the described receiver can be implemented. The computing-based device may be an electronic device. For example, the computing-based device may be a pair of 3D glasses. The computing-based device illustrates functionality used for determining the parameters of a receive window, and for receiving data.

Computing-based device 500 comprises a processor 502 for processing computer executable instructions configured to control the operation of the device in order to perform the synchronisation method. The computer executable instructions can be provided using any computer-readable media such as memory 504. Further software that can be provided at the computer-based device 500 includes receive window logic 506 which implements steps 302 and 304 of FIG. 3. Suitably, the receive window logic 506 includes logic for determining the timing of the receive window, for example pseudo-random seed generating logic and jitter value logic. Alternatively, the pseudo-random seed generator and/or jitter value generator are implemented partially or wholly in hardware. Data store 508 stores data such as the pseudo-random seed received from the transmitter, and the parameters of the receive window. Computing-based device 500 further comprises a transmission interface 510, and a reception interface 512 which implements steps 300 and 308 of FIG. 3. Computing-based device 500 also comprises an output interface 514. For example, the output interface 514 may output instructions to control an electronics device, for example the LC shutters of a pair of 3D glasses.

In FIGS. 4 and 5 a single computing-based device has been illustrated in which the described transmitter may be implemented, and a single computing-based device has been illustrated in which the described receiver may be implemented. However, the functionality of the transmitter may be implemented on separate computing-based devices. Similarly, the functionality of the receiver may be implemented on separate computing-based devices.

In a specific example, the methods described with respect to FIGS. 2 and 3 are implemented in a system in which a 3D content source communicates with one or more pairs of 3D glasses to coordinate the display and reception of a 3D programme. Typically, the 3D content source is a 3D television. The 3D television may be configured to play out alternating 2D images (which the viewer perceives as a continuous 3D image) from a broadcast which the television has received from an external content provider, for example a broadcasting station. Alternatively, the 3D television may be configured to play out alternating 2D images (which the viewer perceives as a continuous 3D image) from a content memory located within the 3D television, for example a removable memory such as a DVD or HDD (hard disk drive) or a fixed memory. Alternatively, the 3D television may be configured to play out alternating 2D images (which the viewer perceives as a continuous 3D image) from a content stream received from the internet.

The transmitter described with respect to FIG. 2 is suitably incorporated within the 3D television. FIG. 6 illustrates an example 3D television. 3D television 600 incorporates computing-based device 400 from FIG. 4. 3D television 600 further comprises processor 602 for processing computer executable instructions configured to control the operation of the television. 3D television 600 further comprises a content store 604 for storing the sequence of 2D images to be displayed. 3D television 600 further comprises display 606 for playing out the sequence of 2D images received from the content store 604 under the control of computing-based device 400. Optionally, 3D television 600 also comprises inputs 608 suitable for receiving user input, for example to select the programme being played out.

The receiver described with respect to FIG. 3 is suitably incorporated within a pair of 3D glasses. Suitably, the 3D glasses have liquid crystal shutters which change state from a visibly transparent state to a visibly dark state on application of a voltage across the liquid crystal layer in the shutters. This is illustrated in FIG. 10. Circuits (a) and (b) show application of a voltage differential across the LC shutter, which results in the light being visibly blocked by the liquid crystal layer. Similarly, the liquid crystal shutters change state from a visibly dark state to a visibly transparent state on removal of the voltage across the liquid crystal layer. This is illustrated in FIG. 10. Circuits (c) and (d) show no voltage differential across the LC shutter, which results in the light being visible through the liquid crystal layer. Hence, the shutters are “opened” and “closed” by application and removal of a voltage across the LC layer of the shutters.

The switches in the circuits shown in FIG. 10 are suitably electronically controlled using MOSFETs driven by Programmable Input/Output signals. Suitably, the receiver controls the activation and deactivation of the voltage across the LC layer of each of the left and right shutters. Suitably, the receiver controls the activation and deactivation of the shutters based on timing information received in a received synchronisation packet, such that the shutter for the right eye opens when the image for the right eye is being displayed by the television and closes when the image for the left eye is being displayed by the television, and such that the shutter for the left eye opens when the image for the left eye is being displayed by the television and closes when the image for the right eye is being displayed by the television.

Suitably, the synchronisation packets transmitted by the transmitter comprise timing information indicative of the times at which the television will display images for reception by left and right eyes.

Thus, the receiver in the 3D glasses uses the timing information in the synchronisation packets to accurately synchronise the opening and closing of the shutters with the alternating images displayed by the 3D television. The receive window of the receiver in the 3D glasses is open for a shorter period than in known glasses and thus the power consumption of the glasses is reduced compared to known glasses.

The advertising packets defined in the Bluetooth specification can be broadcast packets. Suitably, the transmitter in the 3D television broadcasts the advertising packets to a plurality of pairs of 3D glasses, each comprising a receiver as previously described. Each receiver synchronises to the transmitter in the 3D television by implementing the method described with respect to FIG. 3. Thus, a plurality of viewers wearing 3D glasses are able to watch the same 3D display on the television and remain fully synchronised without requiring the transmitter in the television to synchronise with each receiver in the glasses independently.

The applicant draws attention to the fact that the present invention may include any feature or combination of features disclosed herein either implicitly or explicitly or any generalisation thereof, without limitation to the scope of any of the present claims. In view of the foregoing description it will be evident to a person skilled in the art that various modifications may be made within the scope of the invention.

What is claimed is:

1. A transmitter operable in accordance with a protocol which mandates that some transmissions are jittered, the transmitter configured to synchronise with a receiver by:
transmitting a pseudo-random seed to the receiver;
determining a jitter value based on the pseudo-random seed; and
transmitting a synchronisation packet to the receiver at a time determined by the jitter value.

2. A transmitter as claimed in claim 1, wherein the protocol is the Bluetooth Low Energy protocol.

3. A transmitter as claimed in claim 2, wherein the synchronisation packet is a Bluetooth Low Energy advertising packet.

4. A transmitter as claimed in any preceding claim 1, wherein the transmitter is incorporated into a 3D television.

5. A transmitter as claimed in claim 4, wherein the synchronisation packet comprises timing information indicative of the times at which the television displays images for reception by left and right eyes.

6. A method by which a transmitter synchronises with a receiver, the transmitter and receiver operable in accordance with a protocol which mandates that some transmissions are jittered, the method comprising:
transmitting a pseudo-random seed to the receiver;
determining a jitter value based on the pseudo-random seed; and
transmitting a synchronisation packet to the receiver at a time determined by the jitter value.

7. A method as claimed in claim 6, wherein the protocol is the Bluetooth Low Energy protocol and the synchronisation packet is a Bluetooth Low Energy advertising packet.

8. A method as claimed in claim 6, wherein the transmitter is incorporated into a 3D television, and wherein the synchronisation packet comprises timing information indicative of the times at which the television displays images for reception by left and right eyes.

9. A receiver operable in accordance with a protocol which mandates that some transmissions are jittered, the receiver configured to synchronise with a transmitter by:
receiving a pseudo-random seed from the transmitter;
determining timing of a receive window for a synchronisation packet based on the pseudo-random seed;
opening the receive window at the determined time;
receiving the synchronisation packet within the receive window; and
closing the receive window following receipt of the synchronisation packet.

10. A receiver as claimed in claim 9, wherein determining timing of a receive window comprises:
determining an expected time of arrival of the synchronisation packet based on the pseudo-random seed; and
determining a time period of the receive window based on the expected time of arrival of the synchronisation packet.

11. A receiver as claimed in claim 9, wherein the protocol is the Bluetooth Low Energy protocol.

12. A receiver as claimed in claim 9, wherein the receiver is incorporated into a pair of 3D glasses.

13. A receiver as claimed in claim 12, wherein the receiver is further configured to control a timing of shutters of the pair of 3D glasses based on timing information in the synchronisation packet.

14. A method by which a receiver synchronises with a transmitter, the transmitter and receiver operable in accordance with a protocol which mandates that some transmissions are jittered, the method comprising:
receiving a pseudo-random seed from the transmitter;
determining timing of a receive window for a synchronisation packet based on the pseudo-random seed;
opening the receive window at the determined time;
receiving the synchronisation packet within the receive window; and
closing the receive window following receipt of the synchronisation packet.

15. A method as claimed in claim 14, wherein determining timing of a receive window comprises:
determining an expected time of arrival of a synchronisation packet based on the pseudo-random seed; and
determining a time period of the receive window based on the expected time of arrival of the synchronisation packet.

16. A method as claimed in claim 14, wherein the receiver is incorporated into a pair of 3D glasses, the method further comprising:
controlling a timing of shutters of the 3D glasses based on timing information in the synchronisation packet.
